(19) United States
(12) Patent Application Publication
(10) Pub. No.: US 2021/0004727 A1
(43) Pub. Date: Jan. 7, 2021

(54) HYPER-PARAMETER TUNING METHOD FOR MACHINE LEARNING ALGORITHMS USING PATTERN RECOGNITION AND REDUCED SEARCH SPACE APPROACH

(71) Applicant: Mohamad Zaim BIN AWANG PON, Cyberjaya (MY)

(72) Inventor: Mohamad Zaim BIN AWANG PON, Cyberjaya (MY)

(21) Appl. No.: 17/025,759

(22) Filed: Sep. 18, 2020

Related U.S. Application Data
(63) Continuation-in-part of application No. 16/908,499, filed on Jun. 22, 2020.
(60) Provisional application No. 62/867,824, filed on Jun. 27, 2019.

(51) Int. Cl. G06N 20/00; G06K 9/62

(52) U.S. Cl. CPC G06N 20/00; G06K 9/6227

(57) ABSTRACT

A computer-implemented method for hyper-parameter tuning for machine learning algorithms using pattern recognition and reduced search space approach comprising the steps of obtaining outputs from the machine learning models based on a limited number of parameter combination that is obtained using Latin Hypercube sampling; estimating errors for each actual data and predicted data, assuming the data is not there but other data is using pattern recognition technology; determining parameter combination that gives maximum error in prediction using pattern recognition technology; adding the data where the most error will likely occur to an actual dataset in order to increase the accuracy in subsequent prediction; predicting the parameter combination that yields the best accuracy using pattern recognition technology; determining reduced search space for each parameter for subsequent hyper-parameter tuning; and repeating previous steps from step until the highest accuracy is achieved.

### CROSS-REFERENCE TO RELATED APPLICATION

This application claims priority to and benefits of U.S. patent application Ser. No. 16/908,499 filed on Jun. 22, 2020 of which is incorporated by reference herein in its entirety. The phrase “pattern recognition” or “pattern recognition technology” in this document refers to the method in the said patent.

### FIELD OF INVENTION

The present invention relates to the field of machine learning. More particularly, the present invention relates to a method and system of hyper-parameter tuning of machine learning algorithms. The algorithms here can refer to any machine learning algorithms including, but not limited to neural network, decision tree, regression, gradient boost or any other algorithms.

### BACKGROUND OF INVENTION

This section is intended to introduce various aspects of the art, which may be associated with exemplary embodiments of the present invention. This discussion is to assist in providing a framework to facilitate a better understanding of particular aspects of the present invention. Accordingly, it should be understood that this section should be read in this light, and not necessarily as admissions of prior art.

The results, particularly the accuracy of machine learning algorithms depend on the parameter setting. In machine learning, hyperparameter optimization or tuning is the problem of choosing a set of optimal hyperparameters for a learning algorithm. A hyperparameter is a parameter whose value is used to control the learning process. In order to achieve the highest accuracy of results, the hyper-parameter tuning can be done using several methods. The most common method are grid search, random search and Bayesian optimization.

Grid search involves a comprehensive search of the solution space. The traditional way of performing hyperparameter optimization has been grid search, or a parameter sweep, which is simply an exhaustive searching through a manually specified subset of the hyperparameter space of a learning algorithm.

Random search replaces the exhaustive enumeration of all combinations by selecting them randomly. It can outperform grid search, especially when only a small number of hyperparameters affects the final performance of the machine learning algorithm. Since the sampling is random, the number of runs required to reach the optimum solution can still be significant since the random search is not focused.

Bayesian optimization is a global optimization method for noisy black-box functions. Applied to hyperparameter optimization, Bayesian optimization builds a probabilistic model of the function mapping from hyperparameter values to the objective evaluated on a validation set. By iteratively evaluating a promising hyperparameter configuration based on the current model, and then updating it, Bayesian optimization, aims to gather observations revealing as much information as possible about this function and, in particular, the location of the optimum. It tries to balance exploration (hyperparameters for which the outcome is most uncertain) and exploitation (hyperparameters expected close to the optimum). In practice, Bayesian optimization has been shown to obtain better results in fewer evaluations compared to grid search and random search, due to the ability to reason about the quality of experiments before they are run. However, the quality is statistical and statistical measures require quantity and therefore this approach still require a significant number of machine learning experiments.

None of the methodology above utilizes pattern recognition to maximize results from as few simulations as possible. Hence the process to reach the optimum parameter settings require a lot of trials and frequently it is a slow process.

Therefore, there is a need method for a hyper-parameter optimization method and system which addresses the abovementioned drawback.

### SUMMARY OF INVENTION

A computer-implemented method to obtain hyper-parameter values that give best accuracy in machine learning algorithms comprising the steps of obtaining outputs from the machine learning models based on a limited number of parameter combination that is obtained using Latin Hypercube sampling; computing error for each actual data and predicted data assuming the data is not there but other data is using pattern recognition technology, wherein the error is computed for each parameter combination determined from the previous step; determining parameter combination that gives maximum error in prediction using pattern recognition technology (130);

adding the data where the most error will likely occur to an actual dataset in order to increase the accuracy in subsequent prediction (140); predicting the parameter combination that yields the best accuracy using pattern recognition technology (150); determining reduced search space for each parameter for subsequent hyper-parameter tuning (160), wherein the reduced search space is the range that is between the maximum error and the best accuracy; and repeating previous steps from step 110 until the highest accuracy is achieved (170).

In the method, the sampling of the parameter combination can be done via Latin hypercube sampling to obtain as representative sampling as possible despite the limited data. The number of sampling is up to the user, but typically a three-point sampling for each round is sufficient.

In the method, before the best combination is predicted, a potential error is first predicted. The potential error can be predicted by taking out each data with known outcome from a dataset and predicting the outcome as if the data is not there. This is repeated for each data. Therefore, the potential error for each data can be estimated. Subsequently, the parameter that yield the biggest error combination can be predicted. This data point can then be added into the dataset and therefore the biggest error due to using a limited dataset can be mitigated, this is the main reason for predicting the error.

In the method, a limited dataset is used so that the best parameter values can be determined with as little machine learning runs as possible. Therefore, there is saving in terms of computing resources and time.

In the method, the prediction for the parameter combination that gives the largest error and the maximum accuracy was determined using pattern recognition method. This can be done without additional machine learning runs since the pattern recognition method can be used to generate the whole solution space with limited data.

In the method, a search space or a solution space refers to the space between the minimum and maximum value for each parameter. The search space is important since reducing the search space is key in finding the most accurate combination of parameters.

In the method, reduction in the search space allows for most efficient search of the best parameter combination.

Additional aspects, applications and advantages will become apparent given the following description and associated figures.

### BRIEF DESCRIPTION OF DRAWINGS

FIG. 1 shows a flowchart of hyper-parameter tuning method for machine learning algorithms using pattern recognition and reduced search space approach in accordance with an embodiment of the present invention.

FIG. 2 shows a diagram showing the first few selected parameters using Latin hypercube method.

FIG. 3 shows a diagram illustrating the error prediction step of FIG. 1 in accordance with an embodiment of the present invention.

FIG. 4A shows a diagram of the biggest potential error area according to the step (130) of FIG. 1 in accordance with an embodiment of the present invention.

FIG. 4B shows a diagram of the biggest potential error data point selected from the area according to the step (130) of FIG. 1 in accordance with an embodiment of the present invention.

FIG. 5 shows a diagram illustrating prediction of best accuracy according to the step (150) of FIG. 1 in accordance with an embodiment of the present invention.

FIG. 6 shows a diagram illustrating the reduced search space according to the step (160) of FIG. 1 in accordance with an embodiment of the present invention.

### DETAILED DESCRIPTION

Exemplary embodiments are described herein. However, the extent that the following description is specific to a particular embodiment, this is intended to be for exemplary purposes only and simply describes the exemplary embodiments. Accordingly, the invention is not limited to the specific embodiments described below, but rather, it includes all alternatives, modifications, and equivalents falling within the true spirit and scope of appended claims.

The present technological advancement may be described and implemented in the general context of a system and computer methods to be executed by a computer which includes but not limited to mobile technology. Such computer-executable instructions may include programs, routines, objects, components, data structures, and computer software technologies that can be used to perform particular tasks and process abstract data types. Software implementations of the present technological advancement may be coded in different languages for application in a variety of computing platforms and environments. It will be appreciated that the scope and underlying principles of the present invention are not limited to any particular computer software technology.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present technological advancement.

Referring now to the drawings, embodiments of the present technological advancement will be described. The present technological advancement can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present technological advancements are discussed below. The appended drawings illustrate only typical embodiments of the present technological advancement and therefore are not to be considered limiting of its scope and breadth.

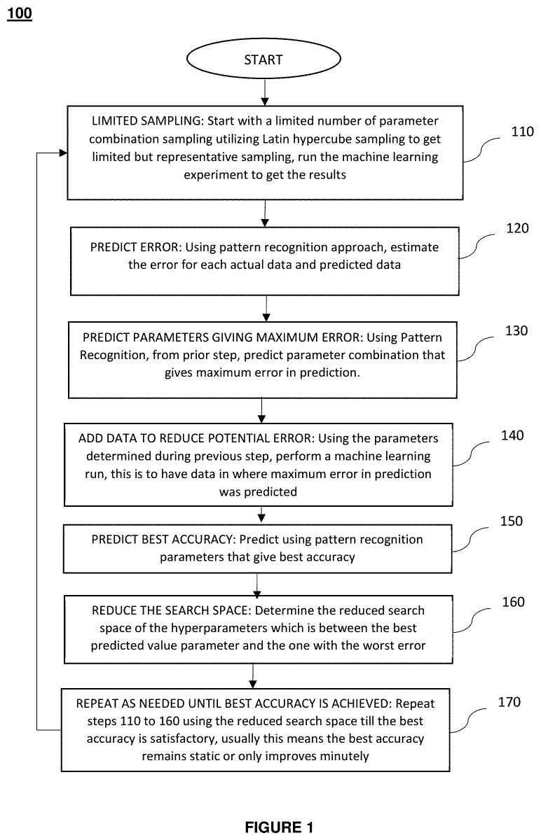

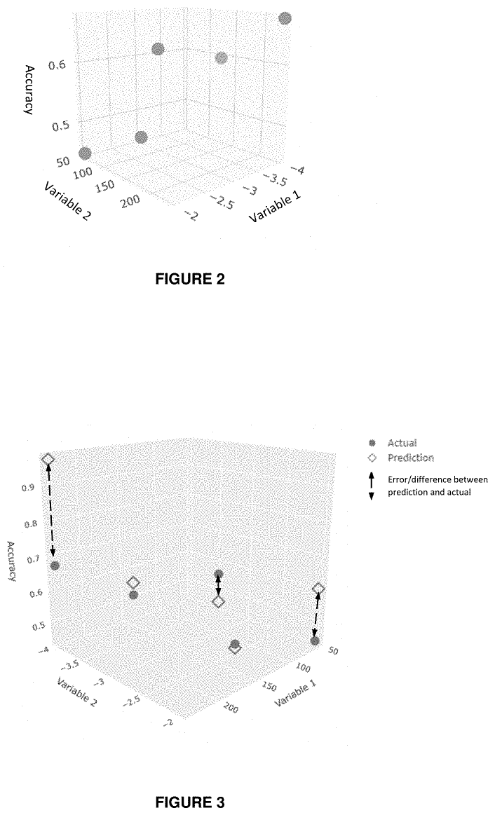

FIG. 1 shows a flowchart of hyper-parameter tuning method for machine learning algorithms using pattern recognition and reduced search space approach in accordance with an embodiment of the present invention. Initially, outputs from the machine learning models are obtained based on a limited number of parameter combination that is obtained using Latin Hypercube sampling as in step 110. The sampling of the parameter combination can be done via Latin Hypercube sampling to obtain as representative sampling as possible despite the limited data. The number of sampling is up to the user, but typically a three-point sampling for each round is sufficient. FIG. 2 illustrates the first few selected parameters using Latin hypercube method.

Next, errors for each actual data and predicted data are estimated as in step 120. Actual data refers to data from the samples known from the machine learning runs, whereas predicted data refers to data predicted using pattern recognition technology assuming the data is not there. In other words, pattern recognition technology is utilized to predict the result for each data as if the data is not there, but the other data points are. FIG. 3 shows a diagram illustrating the error prediction step of FIG. 1 in accordance with an embodiment of the present invention. The error prediction step is a process of removing each data point from a dataset, predicting the results as if the data is unknown. The predicted data, which is the accuracy of the results, is compared to the actual data. The difference between the actual data and the predicted data is then the error in prediction. This is done for each of the data point; therefore, each data point or combination of parameter has an associated error in prediction in addition to the accuracy.

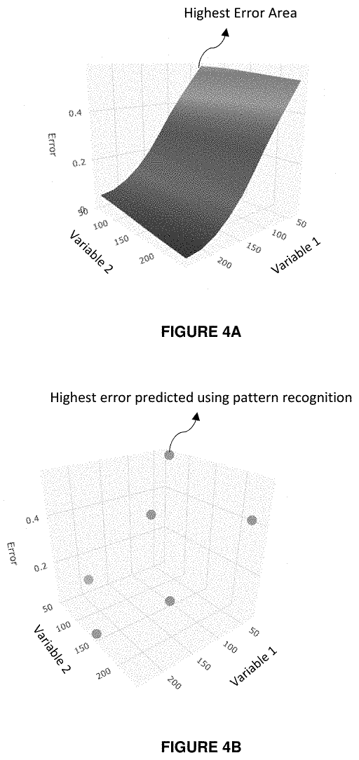

Thereafter, using pattern recognition for the data in the prior step, parameter combination that gives maximum error in prediction is determined as in step 130. This is possible since the prediction error from each data point is available. FIG. 4A shows a diagram of the biggest potential error predicted according to the step (130) of FIG. 1 in accordance with an embodiment of the present invention. Since the error associated for each parameter combination sampled is known, using pattern recognition technology, the biggest error in the solution space can be predicted as shown in FIG. 4B. For the purpose of illustration, it can be assumed here that only two parameters, Variable 1 and Variable 2 as in FIG. 4B are being tuned here.

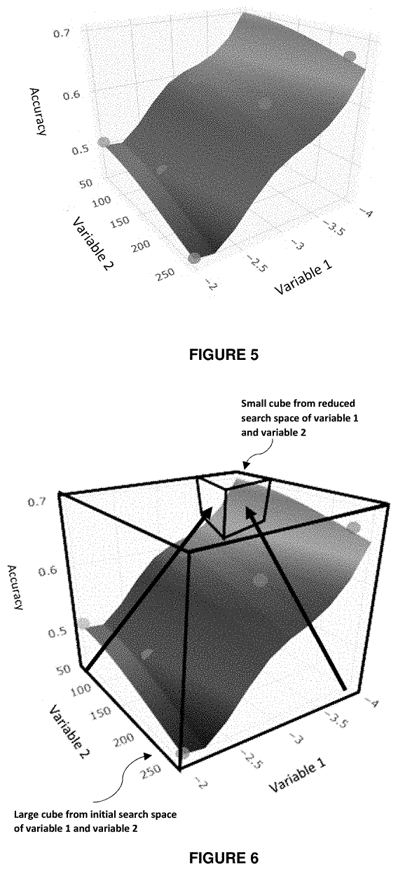

In order to increase the accuracy in subsequent prediction, the data where the most error will likely occur is added to a group of actual data or an actual dataset in order to mitigate the potential shortcoming of limited data as in step 140. Thereon, as the data set from previous step includes the area with biggest error potential, parameters that gives the best accuracy is further predicted using pattern recognition as in step 150. FIG. 5 shows a diagram illustrating prediction of best accuracy according to the step (150) of FIG. 1 in accordance with an embodiment of the present invention. Since the outcome associated for each parameter combination sampled is known before from machine learning runs or predictions using pattern recognition technology, the parameter that give the best accuracy can be predicted. For the purpose of illustration, it can be assumed here that only two parameters are being tuned here.

As mentioned earlier, the process begins with very few data points. After obtaining the parameter with the best accuracy, a reduced search space is determined as in step 160. A search space or a solution space refers to the space between the minimum and maximum value of each parameter. For each parameter, the range that is between the maximum error and the best accuracy is used to define the reduced search space for subsequent iterations. In other words, the solution space outside the range of the biggest error and best accuracy are not included in subsequent step. FIG. 6 shows a diagram illustrating the reduced search space according to the method (160) of FIG. 1 in accordance with an embodiment of the present invention. The reduced search space is a result of predicting the best parameter, thereby reducing the search space. However, this reduction of search space is not done too aggressively since the data point that may have the least accuracy in the pattern recognition due to limited data has been incorporated. For the purpose of illustration, it can be assumed here that only two parameters are being tuned here.

Finally, the process is repeated from step 110 with the reduced search space until the best accuracy is found as in step 170. The process is repeated usually until the best accuracy remains static or only improves minutely.

Advantageously, the present invention allows for rapid converging of the best hyper-parameter combination by using pattern recognition despite limited data use. The solution can be reached even faster by reducing the search space for each iteration, knowing the error and the accuracy for each round of iteration.

From the foregoing, it would be appreciated that the present invention may be modified in light of the above teachings. It is therefore understood that, within the scope of the appended claims, the invention may be practiced otherwise than as specifically described.

1. A computer-implemented method to obtain hyper-parameter values that give best accuracy in machine learning algorithms which comprising the step of:
(a) obtaining outputs from the machine learning models by running machine learning algorithm with a limited number of parameter combination obtained using Latin Hypercube sampling;
(b) estimating errors for each actual data and predicted data, wherein actual data refers to data from the samples known from the machine learning runs, wherein predicted data refers to data predicted using pattern recognition technology assuming the data is not there, and wherein the error refers to the difference between actual data and predicted data;
(c) determining parameter combination that gives maximum error in prediction using pattern recognition technology;
(d) adding the data where the most error will likely occur to an actual dataset in order to improve the accuracy in subsequent prediction;
(e) predicting parameter combination that yields the best accuracy using pattern recognition technology;
(f) determining reduced search space for each parameter for subsequent hyper-parameter tuning, wherein the reduced search space is the range that is between the maximum error and the best accuracy; and
(g) repeating previous steps from step until the highest accuracy is achieved.

2. The method according to claim 1, wherein the step of computing error for each predicted data using pattern recognition technology further comprises the step of removing each data point from a dataset, predicting the data as if the data is unknown and comparing the predicted data with an actual data to estimate error in prediction, and repeating the preceding steps for each data point.

3. The method according to claim 1, wherein a search space is reduced by each parameter having the minimum and maximum determined from the best accuracy predicted and the largest prediction error predicted.
